(19) United States
(12) Patent Application Publication
(10) Pub. No.: US 2025/0106784 A1
(43) Pub. Date: Mar. 27, 2025

(54) METHOD AND APPARATUS FOR FULL POWER TRANSMISSION IN WIRELESS NETWORKS

(71) Applicant: SHARP KABUSHIKI KAISHA, Sakai City (JP)

(72) Inventors: PO-CHUN CHOU, Taipei (TW); MEI-JU SHIH, Taipei (TW); CHIA-HUNG LIN, Taipei (TW); YEN-HUA LI, Taipei (TW); WAN-CHEN LIN, Taipei (TW)

(21) Appl. No.: 18/897,384

(22) Filed: Sep. 26, 2024

Related U.S. Application Data
(60) Provisional application No. 63/585,285, filed on Sep. 26, 2023.

(51) Int. Cl. H04W 52/32; H04B 7/06; H04L 5/00; H04W 72/231

(52) U.S. Cl. CPC H04W 52/325; H04B 7/0639; H04L 5/005; H04W 72/231

(57) ABSTRACT

A method performed by an 8-TX UE for full power transmissions is provided. The method transmits an IE for reporting capability information. The method receives a PUSCH configuration for configuring the 8-TX UE with a CB PUSCH transmission, a full power mode 1, and one of a partial coherent codebook subset with two antenna groups, a partial coherent codebook subset with four antenna groups, and a non-coherent codebook subset. The method receives DCI including an SRI and an additional TPMI for indicating an 8-port SRS resource. The method then performs the CB PUSCH transmission using the full power mode 1. The IE includes a field indicating support for the full power mode 1 and a field indicating support for one of the partial coherent codebook subset with two antenna groups, the partial coherent codebook subset with four antenna groups, and the non-coherent codebook subset.

### CROSS-REFERENCE TO RELATED APPLICATION(S)

The present disclosure claims the benefit of and priority to U.S. Provisional Patent Application Ser. No. 63/585,285, filed on Sep. 26, 2023, entitled “METHOD AND APPARATUS FOR PERFORMING FULL POWER TRANSMISSION FOR AN 8TX UE,” the content of which is hereby incorporated herein fully by reference into the present disclosure for all purposes.

### FIELD

The present disclosure is related to wireless communication and, more specifically, to an 8-transmit (8-TX) User Equipment (UE), Base Station (BS), and method for full power transmission in the wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there exists a need for further improvements in the next-generation wireless communication systems, such as improvements in full power transmissions.

### SUMMARY

The present disclosure is related to an 8-TX UE, a BS, and a method for full power transmission in the wireless communication networks.

In a first aspect of the present disclosure, a method performed by an 8-TX UE for full power transmissions is provided. The method includes transmitting, to a BS, an information element (IE) for reporting capability information; receiving, from the BS, a physical uplink shared channel (PUSCH) configuration for configuring the 8-TX UE with a codebook-based (CB) PUSCH transmission, a full power mode 1, and one of a partial coherent codebook subset with two antenna groups, a partial coherent codebook subset with four antenna groups, and a non-coherent codebook subset; receiving, from the BS, downlink control information (DCI) including a sounding reference signal (SRS) resource indicator (SRI) and an additional transmit precoder matrix indication (TPMI) for indicating an 8-port SRS resource, the additional TPMI corresponding to a precoding matrix with at least one non-zero element in each row; and performing, based on the PUSCH configuration and the DCI, the CB PUSCH transmission using the full power mode 1. The IE includes a first field indicating that the 8-TX UE supports the full power mode 1 and one of the following fields: a second field indicating that the 8-TX UE supports the partial coherent codebook subset with two antenna groups, a third field indicating that the 8-TX UE supports the partial coherent codebook subset with four antenna groups, and a fourth field indicating that the 8-TX UE supports the non-coherent codebook subset.

In some implementations of the first aspect, the method further includes receiving, from the BS, a first radio resource control (RRC) message indicating to the 8-TX UE to report the capability information. Transmitting, to the BS, the IE includes transmitting the IE to the BS through a second RRC message.

In some implementations of the first aspect, the PUSCH configuration is applied to a particular bandwidth part (BWP).

In some implementations of the first aspect, the DCI includes a DCI format 0_1.

In a second aspect of the present disclosure, an 8-TX UE for full power transmissions is provided. The 8-TX UE includes at least one processor and at least one non-transitory computer-readable medium that is coupled to the at least one processor and that stores one or more computer-executable instructions. The one or more computer-executable instructions, when executed by the at least one processor, cause the 8-TX UE to: transmit, to a BS, an IE for reporting capability information; receive, from the BS, a PUSCH configuration for configuring the 8-TX UE with a CB PUSCH transmission, a full power mode 1, and one of a partial coherent codebook subset with two antenna groups, a partial coherent codebook subset with four antenna groups, and a non-coherent codebook subset; receive, from the BS, DCI including an SRI and an additional TPMI for indicating an 8-port SRS resource, the additional TPMI corresponding to a precoding matrix with at least one non-zero element in each row; and perform, based on the PUSCH configuration and the DCI, the CB PUSCH transmission using the full power mode 1. The IE includes a first field indicating that the 8-TX UE supports the full power mode 1 and one of the following fields: a second field indicating that the 8-TX UE supports the partial coherent codebook subset with two antenna groups, a third field indicating that the 8-TX UE supports the partial coherent codebook subset with four antenna groups, and a fourth field indicating that the 8-TX UE supports the non-coherent codebook subset.

In a third aspect of the present disclosure, a BS for managing full power transmissions is provided. The BS includes at least one processor and at least one non-transitory computer-readable medium that is coupled to the at least one processor and that stores one or more computer-executable instructions. The one or more computer-executable instructions, when executed by the at least one processor, cause the BS to: receive, from an 8-TX UE, an IE for reporting capability information; transmit, to the 8-TX UE, a PUSCH configuration for configuring the 8-TX UE with a CB PUSCH reception, a full power mode 1, and one of a partial coherent codebook subset with two antenna groups, a partial coherent codebook subset with four antenna groups, and a non-coherent codebook subset; transmit, to the 8-TX UE, DCI including an SRI and an additional TPMI for indicating an 8-port SRS resource, the additional TPMI corresponding to a precoding matrix with at least one non-zero element in each row; and performing, based on the PUSCH configuration and the DCI, the CB PUSCH reception using the full power mode 1. The IE includes a first field indicating that the 8-TX UE supports the full power mode 1 and one of the following fields: a second field indicating that the 8-TX UE supports the partial coherent codebook subset with two antenna groups, a third field indicating that the 8-TX UE supports the partial coherent codebook subset with four antenna groups, and a fourth field indicating that the 8-TX UE supports the non-coherent codebook subset.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process performed by an 8-TX UE for full power transmissions, according to an example implementation of the present disclosure.

FIG. 2 is a flowchart illustrating a method/process performed by a BS for managing full power transmissions, according to an example implementation of the present disclosure.

FIG. 3 is a block diagram illustrating a node for wireless communication, according to an example implementation of the present disclosure.

### DETAILED DESCRIPTION

Some of the abbreviations used in the present disclosure include:

| Abbreviation | Full name |
|---|---|
| 2-TX | 2-Transmit |
| 4-TX | 4-Transmit |
| 8-TX | 8-Transmit |
| 3GPP | 3^{rd} Generation Partnership Project |
| 5G | 5^{th} Generation |
| ACK | Acknowledgment |
| BS | Base Station |
| BWP | Bandwidth Part |
| C-RNTI | Cell-Radio Network Temporary Identifier |
| CA | Carrier Aggregation |
| CB | Codebook-Based |
| CBRA | Contention-Based Random Access |
| CC | Component Carrier |
| CCE | Control Chanel Element |
| CE | Control Element |
| CFRA | Contention-Free Random Access |
| CG | Configured Grant |
| CHO | Conditional Handover |
| CORESET | Control resource set |
| CPE | Customer Premises Equipment |
| CRC | Cyclic Redundancy Check |
| CS-RNTI | Configured Scheduling-Radio Network Temporary |
| | Identifier |
| CSI | Channel State Information |
| CSI-RS | Channel State Information Reference Signal |
| CSS | Common Search Space |
| DAPS | Dual Active Protocol Stack |
| DC | Dual Connectivity |
| DCI | Downlink Control Information |
| DL | Downlink |
| DMRS | Demodulation Reference Signal |
| E-UTRA | Evolved Universal Terrestrial Radio Access |
| FDD | Frequency Division Duplex |
| FR | Frequency Range |
| FR1 | Frequency Range 1 |
| FR2 | Frequency Range 2 |
| FTP | Full Power Transmission |
| FWA | Fixed Wireless Access |
| GC-PDCCH | Group Common-Physical Downlink Control Channel |
| HARQ | Hybrid Automatic Repeat Request |
| HARQ-ACK | HARQ Acknowledgement |
| HO | Handover |
| ID | Identifier |
| IE | Information Element |
| IIoT | Industrial Internet of Things |
| LSB | Least Significant Bit |
| LTE | Long Term Evolution |
| LTM | Layer 1/Layer 2 Triggered Mobility |
| L1/L2/L3 | Layer 1/Layer 2/Layer 3 |
| MAC | Medium Access Control |
| MAC CE | MAC Control Element |
| MCG | Master Cell Group |
| MCS | Modulation and Coding Scheme |
| MCS-C-RNTI | Modulation Coding Scheme-Cell-Radio Network |
| | Temporary Identifier |
| MIMO | Multi-input Multi-output |
| MSB | Most Significant Bit |
| multi-TRP | multiple Transmission and Reception Point |
| NACK | Negative Acknowledgment |
| NAS | Non-Access Stratum |
| NDI | New Data Indicator |
| NG-RAN | Next Generation RAN |
| Non-CB | non-Codebook-Based |
| NR | New Radio |
| NUL | Normal Uplink |
| NW | Network |
| OFDM | Orthogonal Frequency Division Multiplexing |
| P-MPR | Power management Maximum Power Reduction |
| PBCH | Physical Broadcast Channel |
| PCell | Primary Cell |
| PCI | Physical Cell Identifier |
| PDCCH | Physical Downlink Control Channel |
| PDSCH | Physical Downlink Shared Channel |
| PDU | Protocol Data Unit |
| PH | Power Headroom |
| PHR | Power Headroom Report |
| PHY | Physical (layer) |
| PRACH | Physical Random Access Channel |
| PSCell | Primary Secondary Cell |
| PTAG | Primary Timing Advance Group |
| PTRS | Phase Tracking Reference Signal |
| PUCCH | Physical Uplink Control Channel |
| PUSCH | Physical Uplink Shared Channel |
| QCL | Quasi Co-Location |
| RA | Random Access |
| RACH | Random Access Channel |
| RAN | Radio Access Network |
| RAR | Random Access Response |
| Rel | Release |
| RMSI | Remaining Minimum System Information |
| RNTI | Radio Network Temporary Identifier |
| RRC | Radio Resource Control |
| RS | Reference Signal |
| RSRP | Reference Signal Received Power |
| RSRQ | Reference Signal Received Quality |
| RSSI | Reference Signal Strength Indication |
| RV | Redundancy Version |
| SCell | Secondary Cell |
| SCG | Secondary Cell Group |
| SCS | Subcarrier Spacing |
| SDM | Spatial Division Multiplexing |
| SFN | Single-Frequency Network |
| SINR | Signal to Interference plus Noise Ratio |
| SpCell | Special Cell |
| SR | Scheduling Request |
| SRS | Sounding Reference Signal |
| SRI | SRS Resource Indicator |
| SSB | Synchronization Signal Block |
| STAG | Secondary Timing Advance Group |
| STxMP | Simultaneous Transmission with Multi-Panels |
| TA | Timing Advance |
| TAG | Timing Advance Group |
| TB | Transport Block |
| TBS | Transport Block Size |
| TCI | Transmission Configuration Indicator |
| TDM | Time Division Multiplexing |
| TPC | Transmission Power Control |
| TPMI | Transmit Precoder Matrix Indication |
| TR | Technical Report |
| TRI | Transmit Rank Indication |
| TS | Technical Specification |
| UE | User Equipment |
| UL | Uplink |
| URLLC | Ultra-Reliable and Low-Latency Communication |
| USS | UE-Specific Search Space |
| WCDMA | Wideband Code Division Multiple Access |
| WG | Working Group |
| WI | Working Item |
| ZP-CSI-RS | Zero power CSI-RS |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface. Although the gNB is used as an example in some implementations within the present disclosure, it should be noted that the disclosed implementations may also be applied to other types of base stations.

The BS may be operable to provide radio coverage to a specific geographical area using multiple cells forming the RAN. The BS may support the operations of the cells. Each cell may be operable to provide services to at least one UE within its radio coverage.

Each cell (may often referred to as a serving cell) may provide services to one or more UEs within the cell's radio coverage, such that each cell schedules the DL (and optionally UL resources) to at least one UE within its radio coverage for DL (and optionally UL packet transmissions from the UE). The BS may communicate with one or more UEs in the radio communication system via the cells.

A cell may allocate sidelink (SL) resources for supporting the Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As discussed above, the frame structure for NR may support flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes may be considered for NR, specifically, Low-Density Parity-Check (LDPC) code and Polar Code. The coding scheme adaption may be configured based on channel conditions and/or service applications.

At least the DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which may not restrict the specific method.

In some implementations, all the designs/embodiment/implementations introduced within this disclosure are not limited to be applied for dealing with the problems discussed within this disclosure. For example, the described embodiments may be applied to solve other problems that exist in the RAN of wireless communication systems. In some implementations, all of the numbers listed within the designs/embodiment/implementations introduced within this disclosure are just examples and for illustration, for example, of how the described methods are executed.

The term “A and/or B” within the present disclosure means “A”, “B”, or “A and B”. The term “A and/or B and/or C” within the present disclosure means “A”, “B”, “C”, “A and B”, “A and C”, “B and C”, or “A and B and C”. The term “A/B” within the present disclosure means “A” or “B”.

Examples of some selected terms in the present disclosure are provided as follows.
Antenna Panel: An antenna panel is a conceptual term for a UE antenna implementation. It may be assumed that a panel is an operational unit for controlling a transmitting spatial filter (e.g., beam). A panel may typically include multiple antenna elements. In one implementation, a beam may be formed by a panel, and in order to form two beams simultaneously, two panels may be needed. Such simultaneous beamforming from multiple panels may be subject to the UE's capability. A similar definition for “panel” may be applicable by applying spatial receiving filtering characteristics. The UE panel information may be derived from the TCI state/UL beam indication information, or from the network signaling.
Beam: A beam may refer to a spatial (domain) filtering. As an example, the spatial filtering may be applied in the analog domain by adjusting a phase and/or an amplitude of a signal before being transmitted by a corresponding antenna element. As another example, the spatial filtering may be applied in the digital domain by the Multi-Input Multi-Output (MIMO) technique in the wireless communication system. For example, “a UE made a PUSCH transmission by using a specific beam” may imply that the UE has made the PUSCH transmission using the specific spatial/digital domain filter. The “beam” may also be, but is not limited to be, represented as an antenna, an antenna port, an antenna element, a group of antennas, a group of antenna ports, or a group of antenna elements. The beam may also be formed by a certain reference signal resource. In short, the beam may be equivalent to a spatial domain filter through which the EM wave is radiated. Beam information may include details about the selected or utilized beam or spatial filter. In some implementations, the individual beams (e.g., spatial filters) may be used to transmit individual reference signals. Consequently, a beam or beam information may be represented by one or more reference signal resource indices.
DCI: DCI may include downlink control information, and there may be various DCI formats used in a PDCCH. The DCI format may be a predefined format in which the downlink control information may be packed/formed and transmitted in a PDCCH.
TCI state: A TCI state may include parameters for configuring a QCL relationship between one or more DL reference signals and a target reference signal set. For example, a target reference signal set may include the DMRS ports of a PDSCH, a PDCCH, a PUCCH, or a PUSCH. The reference signals may include UL or DL reference signals. In NR Rel-15/16, the TCI state may be used for a DL QCL indication, whereas the spatial relation information may be used for providing the UL spatial transmission filter information for the UL signal(s) or channel(s). A TCI state may include the information similar to the spatial relation information, which may be used for UL transmission. In other words, from the UL perspective, a TCI state may provide the UL beam information that may indicate the relationship between a UL transmission and the DL or UL reference signals (e.g., the CSI-RS, the SSB, the SRS, and the PTRS).
HARQ: HARQ is a functionality that ensures the delivery between peer entities at Layer 1 (e.g., Physical Layer). A single HARQ process supports one Transport Block (TB) when the physical layer is not configured for the downlink/uplink spatial multiplexing, and when the physical layer is configured for downlink/uplink spatial multiplexing, a single HARQ process may support one or more TBs. There is one HARQ entity per serving cell. Each HARQ entity may support a parallel (number of) DL and UL HARQ process.

Multi-Input Multi-Output (MIMO) is one of the key technologies in NR systems and has been successful in commercial deployments. Over the past ten years, the MIMO features may have been investigated and specified for both frequency division duplexing (FDD) and time division duplexing (TDD) systems, with a focus on downlink MIMO operation. Currently, it may be important to identify and specify necessary enhancements for uplink MIMO. At the same time, enhancements to downlink MIMO may be needed to facilitate the use of a large antenna array. These enhancements should apply not only to frequency range 1 (FR1) but also to frequency range 2 (FR2). Such improvements may be necessary to meet the evolving demands of NR deployments. These enhancements may include the study and, if justified, the specification of uplink DMRS, SRS, SRI, and TPMI (including codebook) improvements to enable 8-TX UL operation, supporting 4 or more layers per UE in the uplink, targeting customer premises equipment (CPE), fixed wireless access (FWA), vehicles, and industrial devices. Potential restrictions on the scope of this objective, including coherence assumptions and full/non-full power modes, may be identified as part of the study. The 8-TX UL operation may refer to a UE with eight antenna ports for uplink transmission.

MIMO technology may be an effective way to increase the throughput of NR systems, such as by increasing the maximum number of transmission layers and/or utilizing beamforming techniques. The enhancement of uplink (UL) MIMO operation in the NR system may continue to evolve based on ongoing hardware advancements. As a result, the scenario of a UE with 8-TX may become increasingly feasible. In this scenario, how to indicate a precoder for the UE may become a potential issue. The size of the supported codebook subset(s), corresponding to different coherence conditions, may increase due to the growing number of antenna ports used for data transmission. Therefore, the nested indication for TPMI may no longer be suitable, and a new TPMI indication mechanism may need to be developed. The nested indication for TPMI may refer to a configuration where a codebook subset may be applied for at least one of three coherence conditions. These conditions include full coherence, partial coherence, and non-coherence.

Additionally, the efficiency of uplink (UL) transmission power utilization may become a potential issue as the number of antenna ports for data transmission increases. The UL transmission power for a UE may be configured by the BS (e.g., gNB), where the configured UL transmission power may be distributed among the antenna ports used for data transmission. The UE may divide all or some of the configured UL transmission power equally among the antenna ports on which the UE transmits PUSCH with non-zero power. When the total transmission power across all antenna ports is equal to the configured UL transmission power, this is referred to as a full power transmission (FPT). The FPT may be performed using different approaches depending on the UE's capability.

The goal of this disclosure is to propose a mechanism for 8-TX PUSCH transmission, including approaches for indicating the TPMI and achieving the FPT.

The terms “an antenna port” and “antenna ports” used in the present disclosure may be referred to as “an antenna port used for the transmission of PUSCH(s)/PUCCH(s)” and “antenna ports used for the transmission of PUSCH(s)/PUCCH(s),” respectively. Additionally, the term “an antenna group” used in the present disclosure may be referred to as “a group including more than one antenna port, where all antenna ports in the group are fully coherent.” Furthermore, the term “an antenna element” used in the present disclosure may be referred to as “an antenna element including two cross-polarized antenna ports.”

Rel-15 4-TX codebooks may include codebooks used for uplink CB transmission when the UE is equipped with four antenna ports or when the UE is configured with an SRS resource set including at least one 4-port SRS resource. The UE may be indicated with an SRI associated with the 4-port SRS resource by the BS/NW.

Rel-15 2-TX codebooks may include codebooks used for uplink CB transmission when the UE is equipped with two antenna ports or when the UE is configured with an SRS resource set including at least one 2-port SRS resource. The UE may be indicated with an SRI associated with the 2-port SRS resource by the BS/NW.

### Codebook-Based (CB) Transmission

A UE may include a device with eight antenna ports (e.g., an 8-TX UE). The CB transmission may represent that the UE transmits data on the PUSCH using a precoder indicated by the BS/NW from a configured codebook subset. The CB transmission may be applicable to a dedicated uplink BWP. The UE may perform the CB transmission on the PUSCH upon receiving a particular IE (e.g., the PUSCH-Config IE). The PUSCH-Config IE may include a particular field (e.g., the txConfig field) set to the “codebook” by the BS/NW.

A configured maximum rank may represent the maximum number of transmission layers that the UE is configured or indicated, by the BS/NW, to perform the PUSCH transmission applicable to a dedicated UL BWP.

In some implementations, the UE may be configured with a maximum rank applicable to the PUSCH transmission scheduled by the DCI format 0_1. The UE may be configured with the maximum rank via the RRC signaling received from the BS/NW. The RRC signaling may include the PUSCH-Config IE that includes a particular field (e.g., maxRank field).

In some implementations, the UE may be configured with a maximum rank applicable to the PUSCH transmission scheduled by the DCI format 0_2. The UE may be configured with the maximum rank via the RRC signaling received from the BS/NW. The RRC signaling may include the PUSCH-Config IF that includes a particular field (e.g., the maxRankDCI-0-2 field).

In some implementations, a UE may be configured with a maximum rank applicable to the PUSCH transmission scheduled by the DCI format 0_1/0_2. The UE may be configured with the maximum rank via the RRC signaling received from the BS/NW. The RRC signaling may include a particular field (e.g., the maxRank maxRankDCI-0-2 field). The maxRank maxRankDCI-0-2 field may be in an integer format. The maxRank maxRankDCI-0-2 field may be set to a value of up to eight/four.

A configured codebook subset may represent the precoder coherence that the UE is indicated/configured, by the BS/NW, to perform the PUSCH transmission applicable to a dedicated UL BWP.

In some implementations, the UE may be configured with a codebook subset applicable to the PUSCH transmission scheduled by the DCI format 0_1. The UE may be configured with the codebook subset via the RRC signaling received from the BS/NW. The RRC signaling may include the PUSCH-Config IE that includes a particular field (e.g., the codebookSubset field).

In some implementations, the UE may be configured with a codebook subset applicable to the PUSCH transmission scheduled by the DCI format 0_2, The UE may be configured with the codebook subset via the RRC signaling received from the BS/NW. The RRC signaling may include the PUSCH-Config IE that includes a particular field (e.g., the codebookSubsetDCI-0-2 field).

In some implementations, a UE may be configured with a codebook subset applicable to the PUSCH transmission scheduled by the DCI format 0_1/0_2. The UE may be configured, by the BS/NW, with the codebook subset via the RRC signaling. The RRC signaling may include a particular field (e.g., the codebookSubset codebookSubsetDCI-0-2 field). The codebookSubset codebookSubsetDCI-0-2 field may be in an enumerated format. The codebookSubset codebookSubsetDCI-0-2 field may be set to a coherence state (e.g., Type A, B, C, D, or E).

Type A may represent that the UE is indicated/configured, by the BS/NW, with the non-coherent precoders (e.g., N_{g}=8). Type B may represent that the UE is indicated/configured, by the BS/NW, with the full-coherent precoders (e.g., N_{g}=1) applicable to (N₁, N₂)=(4, 1). Type C may represent that the UE is indicated/configured, by the BS/NW, with the full-coherent precoders (e.g., N_{g}=1) applicable to (N₁, N₂)=(2,2). Type D may represent that the UE is indicated/configured, by the BS/NW, with partial-coherent precoders, where each partial-coherent precoder may be applicable to N_{g}=2. Type E may represent that the UE may be indicated/configured, by the BS/NW, with the partial-coherent precoders, where each partial-coherent precoder may be applicable to N_{g}=4. N_{g} is the number of antenna groups, N₁ is the number of antenna elements in the first dimension, and N₂ is the number of antenna elements in the second dimension. The type of the codebook subsets that the BS/NW configures to the UE may depend on the UE′ capabilities reported by the UE.

The UE may be indicated/configured, via the RRC signaling/DCI received from the BS/NW, with a precoder for the PUSCH transmission applicable to a dedicated UL BWP. The UE may be indicated/configured, by the BS/NW, with the precoder based on how the PUSCH transmission is scheduled. The PUSCH transmission may be scheduled, by the BS/NW, based on the following three ways: (i) dynamic grant (DG), configured grant type I (CG Type I), and configured grant type II (CG Type II).

If the PUSCH transmission is scheduled by the DG, the UE may receive information associated with a precoder via the DCI format 0_1/0_2 with the CRC scrambled by the C-RNTI. If the PUSCH transmission is scheduled by the CG Type II, the UE may receive information associated with a precoder via the DCI format 0_1/0_2 with the CRC scrambled by the CS-RNTI. If the PUSCH transmission is scheduled by the CG Type I, the UE may receive information associated with a precoder via the RRC signaling that includes a particular IE (e.g., the ConfiguredGrantConfig IE) including a particular field (e.g., the rrc-ConfiguredGrant field).

In some implementations, if the UE is indicated, by the BS/NW, that (i) the usage of the applied SRS resource set is set to “codebook”, (ii) the SRS resource set includes at least one SRS resource with eight antenna ports, (iii) the txConfig field is set to “codebook”, and (iv) the configured codebook subset is set to Type A/B/C/D/E, the UE may be jointly indicated/configured, via the RRC signaling/DCI received from the BS/NW, with the TPMI(s) and a number of transmission layers. The BS/NW may indicate to the UE an index that indicates, from a dedicated table, the combination of the number of transmission layers and the TPMI(s). For example, if the UE is indicated/configured with an index indicating the combination of the TPMI equal to four and the number of transmission layers equal to three, the UE may determine that three layers need to be transmitted on the PUSCH and the indicated precoder corresponds to these three layers with the TPMI of four.

In some implementations, if the UE is indicated, by the BS/NW, that (i) the usage of the applied SRS resource set is set to “codebook”, (ii) the SRS resource set includes at least one SRS resource with eight antenna ports, (iii) the txConfig field is set to “codebook”, and (iv) the configured codebook subset is set to Type D, the UE may be jointly indicated/configured, via the RRC signaling/DCI received from the BS/NW, with a number of transmission layers, one or two TPMI(s), and layer splitting information (e.g., as illustrated in Table 1, as indicated later in the disclosure). The BS/NW may indicate to the UE an index indicating information (e.g., the TPMI(s) and the number of transmission layer(s)) within a dedicated table. The dedicated table may be predefined or configured to the UE via the RRC signaling. The indicated TPMI(s) may be referred to as one or two full-coherent precoders selected from the Rel-15 4-TX codebook.

In some implementations, if the UE is indicated, by the BS/NW, that (i) the usage of the applied SRS resource set is set to “codebook”, (ii) the SRS resource set includes at least one SRS resource with eight antenna ports, (iii) the txConfig field is set to “codebook”, and (iv) the configured codebook subset is set to Type E, the UE may be jointly indicated/configured, via the RRC signaling/DCI received from the BS/NW, with a number of transmission layers, one, two, three, or four TPMI(s), and layer splitting information (e.g., as illustrated in Table 2, as indicated later in the disclosure). The BS/NW may indicate to the UE an index indicating information (e.g., the number of transmission layers and the layer splitting information) within a dedicated table. The dedicated table may be predefined or configured to the UE via the RRC signaling. The indicated TPMI(s) may be referred to as one, two, three, or four full-coherent precoders selected from the Rel-15 2-TX codebook.

The layer splitting information may include a four-tuple selected from Table 2, where the four-tuple may indicate the number of transmission layers assigned to each antenna group. The first element in the four-tuple may indicate the number of transmission layers assigned to the first antenna group, the second element in the four-tuple may indicate the number of transmission layers assigned to the second antenna group, the third element in the four-tuple may indicate the number of transmission layers assigned to the third antenna group, and the fourth element in the four-tuple may indicate the number of transmission layers assigned to the fourth antenna group.

For example, if the UE is indicated or configured with an index indicating that the TPMI is equal to two, the number of transmission layers is equal to one, and the selected four-tuple is (1,0,0,0), and the UE may select, from the Rel-15 2-TX codebook, a precoder with one layer corresponding to the TPMI of two. The UE may then perform, based on the selected precoder, the CB PUSCH transmission on the first antenna group.

In some implementations, a dedicated table may only include the precoders applicable to the corresponding codebook subset. The layer splitting information indicated by the dedicated table may include a two-tuple/four-tuple indicating the number of transmission layers assigned to two/four antenna groups. For example, if a UE is configured with two antenna groups, the UE may obtain, based on the dedicated table, two numbers of transmission layers corresponding, respectively, to two antenna groups. If a UE is configured with four antenna groups, the UE may obtain, based on the dedicated table, two numbers of transmission layers corresponding to two antenna groups respectively.

The UE may be preconfigured with at least one dedicated table used for indicating the TPMI(s) and the number of transmission layers. The UE may determine, based on the RRC signaling and/or DCI received from the BS/NW, a dedicated table indicating the TPMI(s) and the number of transmission layers. For DG, the dedicated table applicable to a dedicated UL BWP may be determined by the UE based on the PUSCH-Config IE and/or the DCI format 0_1/0_2 received from the BS/NW. The BS/NW may indicate to the UE an index indicating the number of transmission layers and the TPMI(s) via a particular field (e.g., the Precoding information and number of layers field or the Second Precoding Information field) included in the DCI format 0_1/0_2.

In some implementations, the UE may determine a dedicated table indicating the TPMI(s) and the number of transmission layers, based on one or more particular fields (e.g., the maxRank maxRankDCI-0-2 field, the txConfig field, the transformPrecoder field, and/or the codebookSubset codebookSubsetDCI-0-2 field) in the PUSCH-Config IE and one or more particular fields (e.g., the SRS resource indicator field and/or the SRS resource set indicator field) in DCI format 0_1/0_2.

In some implementations, the UE may determine the TPMI(s) and the number of transmission layers based on the index indicated by the BS/NW and the dedicated table determined by the UE. In some implementations, the dedicated table determined by the UE may indicate that the number of transmission layers corresponding to the higher index is greater than or equal to the number of transmission layers corresponding to the lower index. In some implementations, the dedicated table determined by the UE, may include one or more indices for each transmission layer.

For a dedicated table, the number of indices indicating the number of transmission layers and the TPMI(s) may increase due to the growing number of antenna ports used for the PUSCH transmission. Consequently, the bitwidth of the corresponding field within the DCI format 0_1/0_2 may also increase. Therefore, how to reduce signaling overhead by decreasing the bitwidth may be considered.

One possible solution is that the UE may determine the bitwidth of the corresponding field based on a configured field (e.g., maxRank maxRank-0-2 field) included in the PUSCH-Config IE applicable to a dedicated UL BWP. In some implementations, if the UE determines a dedicated table based on the DCI/RRC signaling received from the BS/NW, the UE may determine, based on the maxRank maxRank-0-2 field included in the PUSCH-Config IE, the bitwidth of the corresponding field associated with the number of transmission layers and the TPMI(s). The indices may be ignored if the indices indicate the number of transmission layers greater than the value of the maxRank maxRank-0-2 field. For example, if (i) the UE is configured, by the BS/NW, with the maxRank maxRank-0-2 field, (ii) the value of the maxRank maxRank-0-2 field is equal to two, and (iii) the number of indices corresponding to the transmission layers less than three is equal to x, the bitwidth of the corresponding field may be equal to ┌log 2 x┐.

Another possible solution is that a dedicated table determined by the UE may be applied for one single value of the maxRank maxRank-0-2 field. In some implementations, if the UE determines a dedicated table based on the DCI/RRC signaling received from the BS/NW, the UE may determine, based on the maxRank maxRank-0-2 field included in the PUSCH-Config IE, the bitwidth of the corresponding field associated with the number of transmission layers and the TPMI(s). The bitwidth may be determined based on the maximum index in the dedicated table.

### Full Power Transmission

The full power transmission may represent that a UE performs the PUSCH transmission on the active BWP b of the carrier f of the cell c using all the calculated PUSCH transmit power P_{PUSCH,b,f,c}(i,j,q_{d},l), where i includes the PUSCH transmission occasion index, j includes the parameter set configuration index, q_{d} includes the reference index for obtaining the downlink pathloss estimate for the PUSCH and the PUCCH, and I includes the PUSCH power control adjustment state index. The P_{PUSCH,b,f,c}(i,j,q_{d},l) may be the linear value of the calculated PUSCH transmit power P_{PUSCH,b,f,c}(i,j,q_{d},l).

Without any full power design, the UE may split the calculated PUSCH transmit power αP̅_{PUSCH,b,f,c}(i,j,q_{d},l) equally across the antenna ports on which the UE transmits the PUSCH with non-zero power, where a includes a power scaling factor. In some implementations, a may be equal to the ratio of the number of antenna ports with a non-zero PUSCH transmission power to the maximum number of SRS ports supported by the UE in an SRS resource.

An antenna port with non-zero transmit power may indicate that the corresponding row of the indicated precoding matrix has at least one non-zero element in all the columns. Additionally, the full power transmission may be achieved when (i) the number of SRS ports of the indicated SRS resource is equal to the maximum number of SRS ports supported by the UE in an SRS resource, and (ii) the number of antenna ports with a non-zero PUSCH transmission power is equal to the number of SRS ports of the indicated SRS resource.

In order to efficiently utilize the transmit power P_{PUSCH,b,f,c}(i,j,q_{d},l), three full power modes may be introduced. Each full power mode may correspond to a capability associated with the output power of the transmission (TX) chains (e.g., the power amplifiers (PAs)) reported by the UE. For the first mode, called full power mode, the full power transmission may be performed by modifying the calculation of α. In the first mode, the output power of each PA of the UE may reach the full power (e.g., P_{PUSCH,b,f,c}(i,j,q_{d},l)). For the second mode, called full power mode 1, the full power transmission may be performed by introducing an additional TPMI in the configured codebook subset. In the second mode, the output power of each PA of the UE may not reach the full power. For the third mode, called full power mode 2, the full power transmission may be performed by indicating the full power TPMI(s)/antenna groups and modifying the calculation of α. In the third mode, the output power of some of the PAs of the UE may reach the full power.

In some implementations, when the UE receives, from the BS/NW, an RRC message (e.g., the UECapabilityEnquiry message), the UE may transmit, to the gNB/NW, an RRC message (e.g., the UECapabilityInformation message) in response to receiving the UECapabilityEnquiry message. The UECapabilityInformation message may include a particular IE (e.g., the FeatureSetUplink IE). A particular field (e.g., the eight-tx-ul-FullPwrMode field) of the IE may be used to indicate whether the full power mode is supported, and the eight-tx-ul-FullPwrMode field may be in an enumerated format (e.g., ENUMERATED{supported}). If the eight-tx-ul-FullPwrMode field is included in the FeatureSetUplink IE, it may represent that the UE supports the full power mode. If the eight-tx-ul-FullPwrMode field is not included in FeatureSetUplink IE or has a value of “absent”, it may represent that the UE does not support the full power mode.

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the FeatureSetUplink IE. A particular field (e.g., the ul-FullPwrMode field) of the IE may be used to indicate whether the full power mode is supported, and the ul-FullPwrMode field may be in an enumerated format (e.g., ENUMERATED{supported}). If the ul-FullPwrMode field is included in the FeatureSetUplink IE, it may represent that the UE supports the full power mode. If the ul-FullPwrMode field is not included the FeatureSetUplink IE or has a value of “absent”, it may represent that the UE does not support the full power mode.

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the FeatureSetUplink IE. The FeatureSetUplink IE may include a particular field (e.g., the supportedSRS-Resource field). The supportedSRS-Resource field may include a particular field (e.g., the maxNumberSRS-Ports-PerResource field). The maxNumberSRS-Ports-PerResource field may be used to indicate the supported maximum number of SRS ports per SRS resource, and the maxNumberSRS-Ports-PerResource field may be in an enumerated format (e.g., ENUMERATED{n1, n2, n4, n8}). “n1”, “n2”, “n4”, and “n8” may represent that the supported maximum number of SRS ports per SRS resource is one, two, four, and eight, respectively. In some implementations, if (i) the UE transmit, to the BS/NW, the RRC message including the maxNumberSRS-Ports-PerResource field set to eight (e.g., “n8”), and (ii) the UE receives, from the BS/NW, an RRC message including a particular field (e.g., the ul-FullPowerTransmission field) set to “fullpower”, the UE may perform the corresponding PUSCH transmission using the full power mode.

In some implementations, when (i) the UE receives, from the BS/NW, the RRC signaling including the PUSCH configuration information (e.g., the PUSCH-Config IE) applicable to a particular BWP, and (ii) the PUSCH-Config IE includes a particular field (e.g., the eight-tx-ul-FullPower Transmission field) indicating that a full power mode is configured, the UE may perform the corresponding PUSCH transmission using the configured full power mode. The eight-tx-ul-FullPower Transmission field may be used to indicate that one of the full power mode, the full power mode 1, and the full power mode 2 is configured, and eight-tx-ul-FullPowerTransmission field may may be in an enumerated format (e.g., ENUMERATED{fullpower, fullpowerMode1, fullpowerMode2}). “fullpower”, “fullpowerMode1” and “fullpowerMode2” may represent that the UE performs the PUSCH transmission using the full power mode, the full power model, and the full power mode 2, respectively.

In some implementations, when the UE is configured, via the RRC signaling received from the BS/NW, with the full power mode applicable to a particular BWP, the UE may further be configured, via the RRC signaling received from the BS/NW, with an SRS resource set with usage set to “codebook”. The SRS resource set may include one or more SRS resources, and each of the one or more SRS resources may have the same number of SRS ports.

In some implementations, when the UE is configured, via the RRC signaling received from the BS/NW, with the full power mode applicable to a particular BWP, the UE may split the calculated PUSCH transmit power αP̅_{PUSCH,b,f,c}(i,j,q_{d},l) equally across the antenna ports on which the UE transmits the PUSCH with non-zero power, where a is equal to one. In some implementations, the UE may perform the full power transmission regardless of which precoder is selected.

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the FeatureSetUplink IE. A particular field (e.g., the eight-tx-ul-FullPwrMode1 field) of the IE may be used to indicate whether the full power mode 1 is supported, and the eight-tx-ul-FullPwrMode1 field may be in an enumerated format (e.g., ENUMERATED{supported} or ENUMERATED{enable}). If the eight-tx-ul-FullPwrMode1 field is included in FeatureSetUplink IE, it may represent that the UE supports the full power mode 1. If the eight-tx-ul-FullPwrMode1 field is not included in FeatureSetUplink IE or has a value of “absent”, it may represent that the UE does not support the full power mode 1.

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the FeatureSetUplink IE. A particular field (e.g., the ul-FullPwrMode1 field) of the IE may be used to indicate whether the full power mode (e.g., the full power mode 1) is supported, and the ul-FullPwrMode I field may be in an enumerated format (e.g., ENUMERATED{supported}).

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the FeatureSetUplink IE. The FeatureSetUplink IE may include the supportedSRS-Resource field. The supportedSRS-Resource field may include the maxNumberSRS-Ports-PerResource field. The maxNumberSRS-Ports-PerResource field may be used to indicate the supported maximum number of SRS-ports per SRS resource, and the maxNumberSRS-Ports-PerResource field may be in an enumerated format (e.g., ENUMERATED{n1, n2, n4, n8}). “n1”, “n2”, “n4”, and “n8” may represent that the supported maximum number of SRS-ports per SRS resource is one, two, four, and eight, respectively. In some implementations, if (i) the UE transmit, to the BS/NW, the RRC message including the maxNumberSRS-Ports-PerResource field set to eight (e.g., “n8”), and (ii) the UE receives, from the BS/NW, an RRC message including the ul-FullPower Transmission field set to “fullpower 1”, the UE may perform the corresponding PUSCH transmission using the full power mode 1.

In some implementations, when (i) the UE receives, from the BS/NW, the RRC signaling including the PUSCH configuration information (e.g., the PUSCH-Config IE) applicable to a particular BWP, and (ii) the PUSCH-Config IE includes the eight-tx-ul-FullPower Transmission field indicating that a full power mode is configured, the UE may perform the corresponding PUSCH transmission using the configured full power mode. The eight-tx-ul-FullPowerTransmission field may be used to indicate that one of the full power mode, the full power mode 1, and the full power mode 2 is configured, and eight-tx-ul-FullPower Transmission field may be in an enumerated format (e.g., ENUMERATED{fullpower, fullpowerMode1, fullpowerMode2}). “fullpower”, “fullpowerMode1” and “fullpowerMode2” may represent that the UE performs the PUSCH transmission using the full power mode, the full power model, and the full power mode 2, respectively.

In some implementations, when the UE is configured, via the RRC signaling received from the BS/NW, with the full power mode 1 applicable to a particular BWP, the UE may further be configured, via the RRC signaling received from the BS/NW, with an SRS resource set with usage set to “codebook”. The SRS resource set may include one or more SRS resources, and each of the one or more SRS resources may have the same number of SRS ports.

In some implementations, when the UE is configured, via the RRC signaling received from the BS/NW, with the full power mode 1 applicable to a particular (UL) BWP, the UE may only be configured with the codebook subset set to Type A/D/E based on the UE's capability.

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include a particular IE (e.g., the MIMO)-ParametersPerBand IE). The MIMO)-ParametersPerBand IE may include a particular field (e.g., the eight-tx-pusch-TransCoherence field). The eight-tx-pusch-TransCoherence field of the IE may be used to indicate the support of the coherence state for a certain frequency band, and the eight-tx-pusch-TransCoherence field may be in an enumerated format (e.g., ENUMERATED{Type A, Type B, TypeC, Type D, Type E}).

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the MIMO)-ParametersPerBand IE. The MIMO-ParametersPerBand IE may include a particular field (e.g., the eight-tx-pusch-TransCoherence-TypeA eight-tx-pusch-TransCoherence-TypeB eight-tx-pusch-TransCoherence-TypeC eight-tx-pusch-TransCoherence-TypeD) eight-tx-pusch-TransCoherence-TypeF field). The eight-tx-pusch-TransCoherence-TypeA eight-tx-pusch-TransCoherence-TypeB eight-tx-pusch-TransCoherence-TypeC eight-tx-pusch-TransCoherence-TypeD) eight-tx-pusch-TransCoherence-TypeE field may be used to indicate whether Type A/B/C/D/E is supported or not for a certain band, and the eight-tx-pusch-TransCoherence-TypeA eight-tx-pusch-TransCoherence-TypeB eight-tx-pusch-TransCoherence-TypeC eight-tx-pusch-TransCoherence-TypeD) eight-tx-pusch-TransCoherence-TypeF field may be in an enumerated format (e.g., ENUMERATED{supported}).

In some implementations, if the UE supports Type B, the UE may be configured with Type B, Type A, Type D, or Type E via the RRC signaling received from the BS/NW. In some implementations, if the UE supports TypeC, the UE may be configured with TypeC, Type A, Type D, or Type E via the RRC signaling received from the BS/NW. In some implementations, if the UE supports Type D, the UE may be configured with Type D or Type A via the RRC signaling received from the BS/NW. In some implementations, if the UE supports Type E, the UE may be configured with Type E or Type A via the RRC signaling received from the BS/NW.

In some implementations, if the UE supports Type A, the UE may only be configured with Type A via the RRC signaling received from the BS/NW. In some implementations, if the UE supports Type B, the UE may only be configured with Type B via the RRC signaling received from the BS/NW. In some implementations, if the UE supports TypeC, the UE may only be configured with TypeC via the RRC signaling received from the BS/NW. In some implementations, if the UE supports Type D, the UE may only be configured with Type D via the RRC signaling received from the BS/NW. In some implementations, if the UE supports Type E, the UE may only be configured with Type E via the RRC signaling received from the BS/NW.

In some implementations, if the UE is configured with the full power mode 1 and the codebook subset is set to Type A/D/E via the RRC signaling received from the BS/NW, the additional precoder(s) may be included in a dedicated table used to indicate a precoder of the CB PUSCH transmission. The additional precoder may be expressed as follows:

For 1 layer:

$$\frac{1}{2 \sqrt{2}} [ \begin{matrix}{x}_{1} \\ ⋮ \\ {x}_{8}\end{matrix} ] ,$$

where xᵢ is the element in ith row, xᵢ∈{1,−1,j,−j} and i=1, . . . , 8.

For k layer:

$$\frac{1}{β} [ \begin{matrix}{x}_{1 , 1} & … & {x}_{1 , k} \\ ⋮ & ⋱ & ⋮ \\ {x}_{8 , 1} & … & {x}_{8 , k}\end{matrix} ] ,$$

where x_{i,m} is the element in the ith row and mth column, and x_{i,m}∈{0,1,−1,j,−j}. At least one element in each row is non-zero, i=1, . . . , 8, and m=1, . . . , k. β is equal to

$$\frac{1}{2 \sqrt{2}}$$

if non-Zero elements is less than or equal to eight, and β is equal to

$$\frac{1}{\sqrt{the number of non - zero elements}}$$

if the number of non-zero elements is greater than eight.

In some implementations, when (i) the UE is configured, via the RRC signaling received from the BS/NW, with the full power mode applicable to a particular BWP, and (ii) each SRS resource in the configured SRS resource set with usage set to “codebook” has more than one SRS port, the calculated PUSCH transmit power αP̅_{PUSCH,b,f,c}(i,j,q_{d},l) may spread across the antenna ports, where a is equal to the ratio of a number of antenna ports with non-zero PUSCH transmission power to the maximum number of SRS ports supported by the UE in an SRS resource.

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the FeatureSetUplink IE. If the UECapabilityInformation message includes information for the support of the full power mode 2, the FeatureSetUplink IE may include three particular fields (e.g., the eight-tx-ul-FullPwrMode2-MaxSRS-ResInSet field, the eight-tx-ul-FullPwrMode2-SRSConfig-diffNumSRSPorts field, and the eight-tx-ul-FullPwrMode2-FullPwrGroup field).

The eight-tx-ul-FullPwrMode2-MaxSRS-ResInSet field may indicate that the UE supports the maximum number of SRS resources in an SRS resource set with usage set to “codebook” for an 8-TX uplink full power Mode 2 operation. The eight-tx-ul-FullPwrMode2-SRSConfig-diffNumSRSPorts field may indicate that the UE supports an SRS configuration with different number of antenna ports per SRS resource for an 8-TX uplink full power Mode 2 operation. The eight-tx-ul-FullPwrMode2-FullPwrGroup field may indicate that the UE supports the full power group(s) which means that the UE is capable of delivering the full power, where the full power group(s) may represent the antenna/TPMI group(s).

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the FeatureSetUplink IE. If the UECapabilityInformation message includes information for the support of the full power mode 2, the FeatureSetUplink IE may include three particular fields (e.g., the ul-FullPwrMode2-MaxSRS-ResInSet field, the ul-FullPwrMode2-SRSConfig-diffNumSRSPorts field, and the ul-FullPwrMode2-TPMIGroup field).

In some implementations, when the UE receives, from the BS/NW, the UECapabilityEnquiry message, the UE may transmit, to the BS/NW, the UECapabilityInformation message in response to receiving the UECapabilityEnquiry message. The UECapabilityInformation message may include the FeatureSetUplink IE. The FeatureSetUplink IE may include the supportedSRS-Resource field. The supportedSRS-Resource field may include the maxNumberSRS-Ports-PerResource field. The maxNumberSRS-Ports-PerResource field may be used to indicate the supported maximum number of SRS ports per SRS resource, and the maxNumberSRS-Ports-PerResource field may be in an enumerated format (e.g., ENUMERATED{n1, n2, n4, n8}). In some implementations, if (i) the UE transmit, to the BS/NW, the RRC message including the maxNumberSRS-Ports-PerResource field set to eight (e.g., “n8”), and (ii) the UE receives, from the BS/NW, an RRC message including the ul-FullPower Transmission field set to “fullpower 2”, the UE may perform the corresponding PUSCH transmission using the full power mode 2.

In some implementations, when (i) the UE receives, from the BS/NW, the RRC signaling including the PUSCH configuration information (e.g., the PUSCH-Config IE) applicable to a particular (UL) BWP, and (ii) the PUSCH-Config IE includes the eight-tx-ul-FullPower Transmission field indicating that the full power mode 2 is configured, the UE may perform the corresponding PUSCH transmission using the full power mode 2. The eight-tx-ul-FullPower Transmission field may be used to indicate that one of the full power mode, the full power mode 1, and the full power mode 2 is configured, and eight-tx-ul-FullPower Transmission field may be in an enumerated format (e.g., ENUMERATED{fullpower, fullpowerMode1, fullpowerMode2}).

In some implementations, when the UE is configured, via the RRC signaling received from the BS/NW, with the full power mode 2 applicable to a particular (UL) BWP, the UE may further be configured, via the RRC signaling received from the BS/NW, with an SRS resource set with usage set to “codebook”. In some implementations, the SRS resource set may include one or more SRS resources, and each of the one or more SRS resources may have the same number of SRS ports. In some implementations, the SRS resource set may include one or more SRS resources, and each of the one or more SRS resources may have a different number of SRS ports.

In some implementations, when the UE is configured with the full power mode 2 and the codebook subset is set to Type D/E, the UE may be further configured, via the RRC signaling received from the BS/NW, with at least one 8-port SRS resource, a 4-port SRS resource, and/or a 2-port SRS resource in the configured SRS resource set with usage set to “codebook”. The RRC signaling may include a particular IE (e.g., the SRS-Config IE).

In some implementations, when (i) the UE transmit, to BS/NW, the RRC signaling including the eight-tx-ul-FullPwrMode2-FullPwrGroup field indicating that one, two, three, or four antenna groups may be used to transmit at full power, and (ii) the UE is indicated/configured with a precoder, the non-zero power antenna port(s) of which, is on the reported antenna group(s), the UE may split the calculated PUSCH transmit power αP̅_{PUSCH,b,f,c}(i,j,q_{d},l) equally across the antenna ports on which the UE transmits the PUSCH with non-zero power, where a is equal to one.

In some implementations, when (i) the UE transmit, to BS/NW, the RRC signaling including the eight-tx-ul-FullPwrMode2-FullPwrGroup field that indicates that one, two, three, or four antenna groups may be used to transmit at full power, and (ii) the UE is indicated/configured with a precoder, the non-zero power antenna port(s) of which, is not on the reported antenna group(s), the UE may split the calculated PUSCH transmit power αP̅_{PUSCH,b,f,c}(i,j,q_{d},l) equally across the antenna ports on which the UE transmits the PUSCH with non-zero power, where a is equal to the ratio of a number of antenna ports with non-zero PUSCH transmission power to a number of SRS ports of the indicated SRS resource.

In some implementations, when the UE is configured, by the BS/NW, with the full power mode 2 and the txConfig field is set to “codebook”, the bitwidth of the field indicating the precoding information and the number of transmission layers may be determined based on the maximum number of SRS ports in an SRS resource among the configured SRS resources in all SRS resource sets with usage set to “codebook”. The field indicating the precoding information and the number of transmission layers may be included in the DCI format 0_1/0_2.

In some implementations, when (i) the UE is configured, via the RRC signaling received from the BS/NW, with the full power mode 2, and (ii) the number of SRS ports of the indicated SRS resource is less than the maximum number of ports in an SRS resource among the configured SRS resources in all SRS resource sets, a number of MSBs with the value set to ‘0’ may be inserted into the corresponding field indicating the precoding information and the number of transmission layers.

When the UE is configured, via the RRC signaling, the MAC CE, or the DCI received from the BS/NW, with the coherence capability to associate the UE, the combinations of layer splitting may be based on Table 1. Table 1 below illustrates combinations of layer splitting for two antenna groups, according to an example implementation of the present disclosure.

TABLE 1

| | All layers in one | Layers split across 2 |
|---|---|---|
| Rank | Antenna Group | Antenna Groups |
| 1 | (1, 0), (0, 1) | |
| 2 | (2, 0), (0, 2) | |
| 2 | | (1, 1) |
| 3 | (3, 0), (0, 3) | |
| 3 | | (1, 2), (2, 1) |
| 4 | (4, 0), (0, 4) | |
| 4 | | (2, 2) |
| 5 | | (2, 3) |
| 6 | | (3, 3) |
| 7 | | (3, 4) |
| 8 | | (4, 4) |

The first number in each pair may represent the number of transmission layers assigned to the first antenna group, while the second number in the pair may represent the number of transmission layers assigned to the second antenna group. Some combinations may be excluded if they do not provide significant benefits to the overall system performance.

When the UE is configured, via the RRC signaling, the MAC CE, or the DCI received from the BS/NW, with the coherence capability to associate the UE, the combinations of layer splitting may be based on Table 2. Table 2 below illustrates combinations of layer splitting for four antenna groups, according to an example implementation of the present disclosure.

TABLE 2

| | All layers in one | Layers split across 4 |
|---|---|---|
| Rank | Antenna Group | Antenna Groups |
| 1 | (1, 0, 0, 0), (0, 1, 0, 0), | |
| | (0, 0, 1, 0), (0, 0, 0, 1) | |
| 2 | (2, 0, 0, 0), (0, 2, 0, 0), | |
| | (0, 0, 2, 0), (0, 0, 0, 2) | |
| 2 | | (1, 1, 0, 0), (1, 0, 1, 0), |
| | | (1, 0, 0, 1), (0, 1, 1, 0), |
| | | (0, 0, 1, 1) |
| 3 | | (2, 1, 0, 0), (2, 0, 1, 0), |
| | | (2, 0, 0, 1), (0, 2, 1, 0), |
| | | (0, 2, 0, 1), (0, 0, 2, 1), |
| | | (1, 1, 1, 0), (1, 1, 0, 1), |
| | | (1, 0, 1, 1), (0, 1, 1, 1) |
| 4 | | (1, 1, 1, 1), (2, 0, 1, 1), |
| | | (2, 1, 0, 1), (2, 1, 1, 0), |
| | | (0, 2, 1, 1), (1, 2, 0, 1), |
| | | (1, 2, 1, 0), (0, 1, 2, 1), |
| | | (1, 0, 2, 1), (1, 1, 2, 0) |
| 5 | | (2, 0, 2, 1), (0, 2, 2, 1), |
| | | (1, 1, 2, 1) |
| 6 | | (2, 2, 2, 0), (2, 0, 2, 2), |
| | | (2, 1, 2, 1) |
| 7 | | (2, 1, 2, 2) |
| 8 | | (2, 2, 2, 2) |

The first element in each 4-tuple may represent the number of transmission layers assigned to the first antenna group, the second element in each 4-tuple may represent the number of transmission layers assigned to the second antenna group, and the third element in each 4-tuple may represent the number of transmission layers assigned to the third antenna group, and the fourth element in each 4-tuple may represent the number of transmission layers assigned to the fourth antenna group. Some combinations may be excluded if they do not provide significant benefits to system performance.

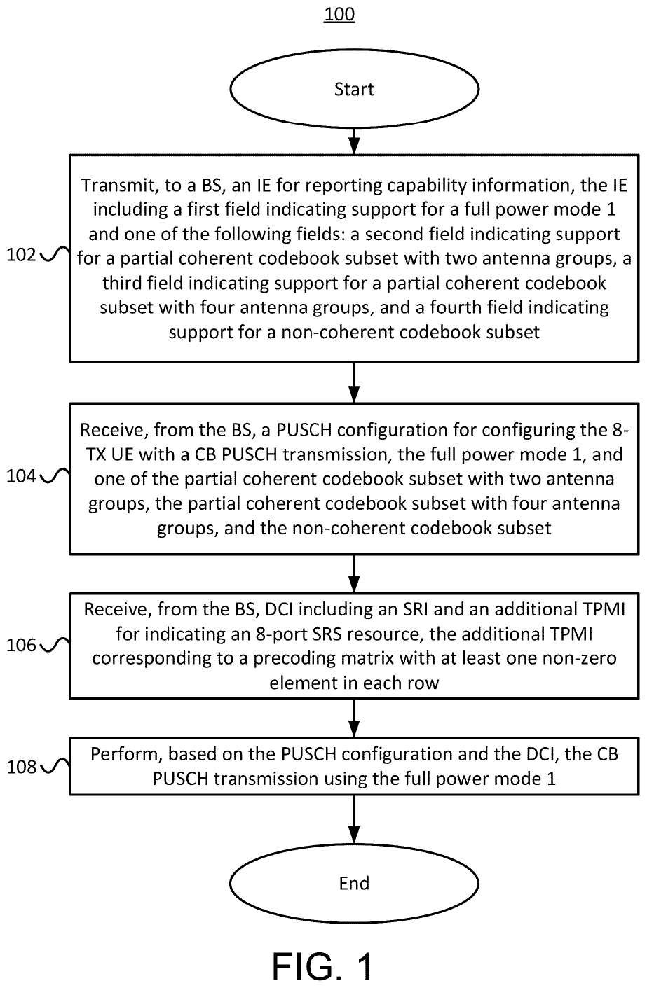

FIG. 1 is a flowchart illustrating a method/process 100 performed by an 8-TX UE for full power transmissions, according to an example implementation of the present disclosure.

In action 102, the process 100 may start by transmitting, to a BS, an IE for reporting capability information. The IE may include a first field indicating that the 8-TX UE supports a full power mode 1. The IE may further include one of a second field, a third field, and a fourth filed. The second field may indicate that the 8-TX UE supports a partial coherent codebook subset with two antenna groups. The third field may indicate that the 8-TX UE supports a partial coherent codebook subset with four antenna groups. The fourth field may indicate that the 8-TX UE supports a non-coherent codebook subset. In some implementations, the process 100 may further receive, from the BS, a first RRC message indicating to the 8-TX UE to report the capability information, and transmit, to the BS, a second RRC message. The IE may be transmitted to the BS through the second RRC message.

In action 104, the process 100 may receive, from the BS, a PUSCH configuration for configuring the 8-TX UE with a CB PUSCH transmission, the full power mode 1, and one of the partial coherent codebook subset with two antenna groups, the partial coherent codebook subset with four antenna groups, and the non-coherent codebook subset. In some implementations, the PUSCH configuration may be applied to a particular BWP.

In action 106, the process 100 may receive, from the BS, DCI including an SRI and an additional TPMI for indicating an 8-port SRS resource. The additional TPMI may correspond to a precoding matrix with at least one non-zero element in each row. In some implementations, the DCI may include a DCI format 0_1.

In action 108, the process 100 may perform, based on the PUSCH configuration and the DCI, the CB PUSCH transmission using the full power mode 1. The process 100 may then end.

The steps/actions shown in FIG. 1 should not be construed as necessarily order dependent. The order in which the process is described is not intended to be construed as a limitation. Moreover, some of the actions shown in FIG. 1 may be omitted in some implementations and one or more actions shown in FIG. 1 may be combined.

The technical problem addressed by the method illustrated in FIG. 1 is how to enable an 8-TX UE to efficiently perform full power transmissions while accommodating different codebook configurations. This involves ensuring that the UE may report its capabilities, configure appropriate codebook subsets, and manage uplink transmission power to optimize performance in diverse antenna configurations. By allowing the 8-TX UE to transmit capability information and dynamically configure codebook-based PUSCH transmissions in full power mode 1, The method enhances the efficiency of uplink communication. This ensures optimal power distribution, improves signal quality, and increases overall uplink performance in various 5G antenna configurations.

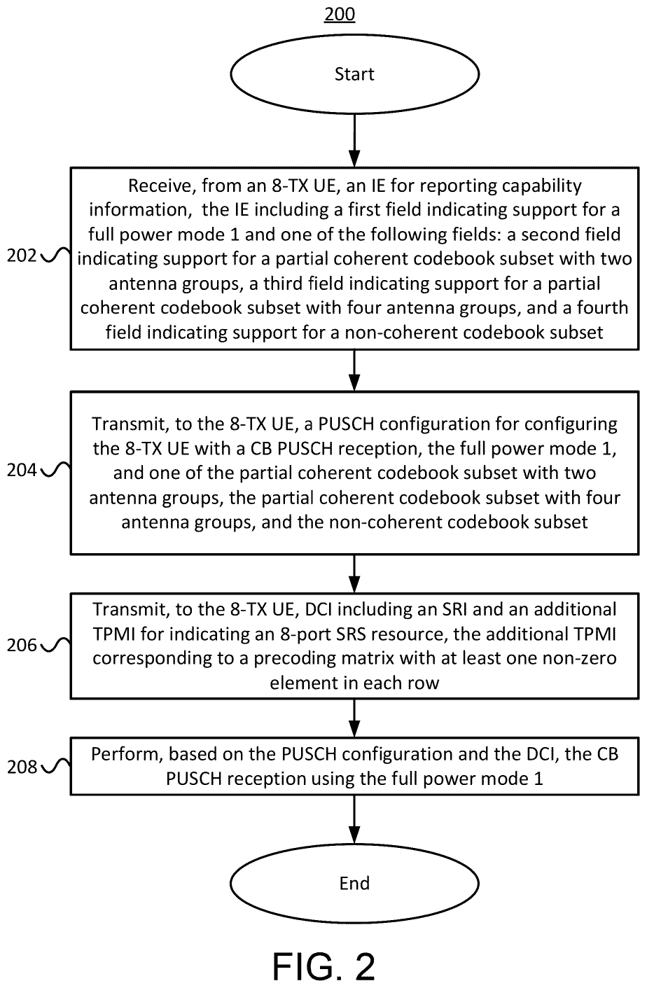

FIG. 2 is a flowchart illustrating a method/process 200 performed by a BS for managing full power transmissions, according to an example implementation of the present disclosure.

In action 202, the process 200 may start by receiving, from an 8-TX UE, an IE for reporting capability information. The IE may include a first field indicating that the 8-TX UE supports a full power mode 1. The IE may further include one of a second field, a third field, and a fourth filed. The second field may indicate that the 8-TX UE supports a partial coherent codebook subset with two antenna groups. The third field may indicate that the 8-TX UE supports a partial coherent codebook subset with four antenna groups. The fourth field may indicate that the 8-TX UE supports a non-coherent codebook subset. In some implementations, the process 200 may further transmit, to the 8-TX UE, a first RRC message indicating to the 8-TX UE to report the capability information, and receive, from the 8-TX UE, a second RRC message. The IE may be received from the 8-TX UE through the second RRC message.

In action 204, the process 200 may transmit, to the 8-TX UE, a PUSCH configuration for configuring the 8-TX UE with a CB PUSCH reception, the full power mode 1, and one of the partial coherent codebook subset with two antenna groups, the partial coherent codebook subset with four antenna groups, and the non-coherent codebook subset. In some implementations, the PUSCH configuration may be applied to a particular BWP.

In action 206, the process 200 may transmit, to the 8-TX UE, DCI including an SRI and an additional TPMI for indicating an 8-port SRS resource. The additional TPMI may correspond to a precoding matrix with at least one non-zero element in each row. In some implementations, the DCI may include a DCI format 0_1.

In action 208, the process 200 may perform, based on the PUSCH configuration and the DCI, the CB PUSCH reception using the full power mode 1. The process 200 may then end. The method illustrated in FIG. 2 is similar to that in FIG. 1, except that it is described from the perspective of the BS (instead of the 8-TX UE).

The steps/actions shown in FIG. 2 should not be construed as necessarily order dependent. The order in which the process is described is not intended to be construed as a limitation. Moreover, some of the actions shown in FIG. 2 may be omitted in some implementations and one or more actions shown in FIG. 2 may be combined.

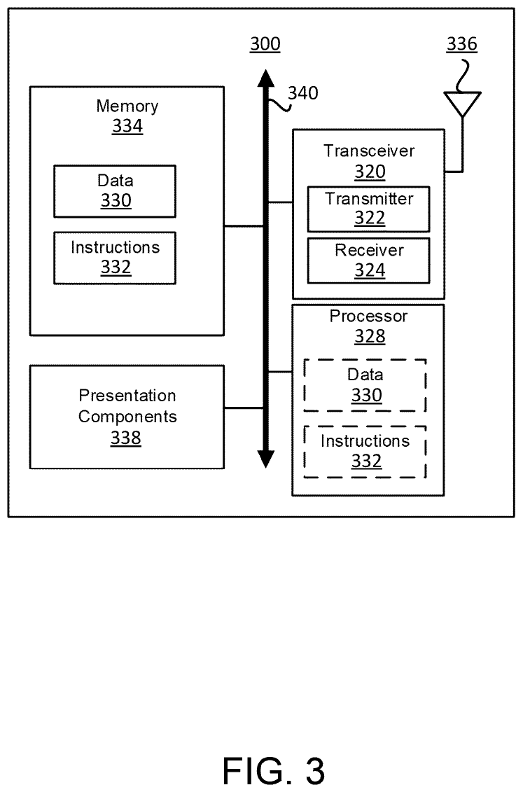

FIG. 3 is a block diagram illustrating a node 300 for wireless communication, according to an example implementation of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3). FIG. 3 is a block diagram illustrating a node for wireless communication, according to an example implementation of the present disclosure.

Each of the components may directly or indirectly communicate with each other over one or more buses 340. The node 300 may be a UE or a BS that performs various functions disclosed with reference to FIGS. 1 and 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 and 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by an 8-transmit (TX) user equipment (UE) for full power transmissions, the method comprising:
transmitting, to a base station (BS), an information element (IE) for reporting capability information;
receiving, from the BS, a physical uplink shared channel (PUSCH) configuration for configuring the 8-TX UE with a codebook-based (CB) PUSCH transmission, a full power mode 1, and one of a partial coherent codebook subset with two antenna groups, a partial coherent codebook subset with four antenna groups, and a non-coherent codebook subset;
receiving, from the BS, downlink control information (DCI) comprising a sounding reference signal (SRS) resource indicator (SRI) and an additional transmit precoder matrix indication (TPMI) for indicating an 8-port SRS resource, the additional TPMI corresponding to a precoding matrix with at least one non-zero element in each row; and
performing, based on the PUSCH configuration and the DCI, the CB PUSCH transmission using the full power mode 1, wherein the IE comprises a first field indicating that the 8-TX UE supports the full power mode 1 and one of the following fields:
a second field indicating that the 8-TX UE supports the partial coherent codebook subset with two antenna groups,
a third field indicating that the 8-TX UE supports the partial coherent codebook subset with four antenna groups, and
a fourth field indicating that the 8-TX UE supports the non-coherent codebook subset.

2. The method of claim 1, further comprising:
receiving, from the BS, a first radio resource control (RRC) message indicating to the 8-TX UE to report the capability information, wherein
transmitting, to the BS, the IE comprises transmitting the IE to the BS through a second RRC message.

3. The method of claim 1, wherein the PUSCH configuration is applied to a particular bandwidth part (BWP).

4. The method of claim 1, wherein the DCI comprises a DCI format 0_1.

5. An 8-transmit (8-TX) user equipment (UE) for full power transmissions, the 8-TX UE comprising:
at least one processor; and
at least one non-transitory computer-readable medium coupled to the at least one processor and storing one or more computer-executable instructions that, when executed by the at least one processor, cause the 8-TX UE to:
transmit, to a base station (BS), an information element (IE) for reporting capability information;
receive, from the BS, a physical uplink shared channel (PUSCH) configuration for configuring the 8-TX UE with a codebook-based (CB) PUSCH transmission, a full power mode 1, and one of a partial coherent codebook subset with two antenna groups, a partial coherent codebook subset with four antenna groups, and a non-coherent codebook subset;
receive, from the BS, downlink control information (DCI) comprising a sounding reference signal (SRS) resource indicator (SRI) and an additional transmit precoder matrix indication (TPMI) for indicating an 8-port SRS resource, the additional TPMI corresponding to a precoding matrix with at least one non-zero element in each row; and
perform, based on the PUSCH configuration and the DCI, the CB PUSCH transmission using the full power mode 1, wherein the IE comprises a first field indicating that the 8-TX UE supports the full power mode 1 and one of the following fields:
a second field indicating that the 8-TX UE supports the partial coherent codebook subset with two antenna groups,
a third field indicating that the 8-TX UE supports the partial coherent codebook subset with four antenna groups, and
a fourth field indicating that the 8-TX UE supports the non-coherent codebook subset.

6. The 8-TX UE of claim 5, wherein the one or more computer-executable instructions, when executed by the at least one processor, further cause the 8-TX UE to:
receive, from the BS, a first radio resource control (RRC) message indicating to the 8-TX UE to report the capability information, wherein
transmitting, to the BS, the IE comprises transmitting the IE to the BS through a second RRC message.

7. The 8-TX UE of claim 5, wherein the PUSCH configuration is applied to a particular bandwidth part (BWP).

8. The 8-TX UE of claim 5, wherein the DCI comprises a DCI format 0_1.

9. A base station (BS) for managing full power transmissions, the BS comprising:
at least one processor; and
at least one non-transitory computer-readable medium coupled to the at least one processor and storing one or more computer-executable instructions that, when executed by the at least one processor, cause the BS to:
receive, from an 8-transmit (8-TX) user equipment (UE), an information element (IE) for reporting capability information;
transmit, to the 8-TX UE, a physical uplink shared channel (PUSCH) configuration for configuring the 8-TX UE with a codebook-based (CB) PUSCH reception, a full power mode 1, and one of a partial coherent codebook subset with two antenna groups, a partial coherent codebook subset with four antenna groups, and a non-coherent codebook subset;
transmit, to the 8-TX UE, downlink control information (DCI) comprising a sounding reference signal (SRS) resource indicator (SRI) and an additional transmit precoder matrix indication (TPMI) for indicating an 8-port SRS resource, the additional TPMI corresponding to a precoding matrix with at least one non-zero element in each row; and
performing, based on the PUSCH configuration and the DCI, the CB PUSCH reception using the full power mode 1, wherein the IE comprises a first field indicating that the 8-TX UE supports the full power mode 1 and one of the following fields:
a second field indicating that the 8-TX UE supports the partial coherent codebook subset with two antenna groups,
a third field indicating that the 8-TX UE supports the partial coherent codebook subset with four antenna groups, and
a fourth field indicating that the 8-TX UE supports the non-coherent codebook subset.

10. The BS of claim 9, wherein the one or more computer-executable instructions, when executed by the at least one processor, further cause the BS to:
transmit, to the 8-TX UE, a first radio resource control (RRC) message indicating to the 8-TX UE to report the capability information, wherein
receiving, from the 8-TX UE, the IE comprises receiving the IE from the 8-TX UE through a second RRC message.

11. The BS of claim 9, wherein the PUSCH configuration is applied to a particular bandwidth part (BWP).

12. The BS of claim 9, wherein the DCI comprises a DCI format 0_1.
